(19) United States
(12) Patent Application Publication
(10) Pub. No.: US 2009/0101009 A1
(43) Pub. Date: Apr. 23, 2009

(54) Core separator integration for mercury removal from flue gases of coal-fired boilers

(75) Inventors: Yehia F. Khalil, Glastonbury, CT (US); Sergei F. Burlatsky, West Hartford, CT (US); Zissis A. Dardas, Worcester, MA (US); Eric J. Gottung, Simsbury, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/977,004

(22) Filed: Oct. 23, 2007

(51) Int. Cl. B01D 53/12; B03C 3/017

(52) U.S. Cl. 95/58; 95/108; 96/140; 96/27

(57) ABSTRACT

A method of separating a coal particle-laden gas mixture into a flue gas recirculation stream and a concentrated sorbent stream includes initiating combustion of a mixture of air and coal in a combustion chamber, extracting a mixture of flue gas and partially-combusted coal particles from the combustion chamber, inducing flow of the mixture of flue gas and partially-combusted coal particles toward a core separator apparatus, and separating the mixture of flue gas and partially-combusted coal particles into the flue gas recirculation stream and the concentrated sorbent stream using a centrifugal action of the core separator apparatus. The recirculation stream and the concentrated sorbent stream flow out of the core separator apparatus on a substantially continuous basis.

### BACKGROUND

The present invention relates to a method and apparatus for mechanically separating a particle-laden gas mixture into a “clean” gas recirculation stream and a concentrated sorbent stream. More specifically, the present invention relates to a method of continuously separating a particle-laden gas mixture into two separate streams and reintroducing these streams into different locations of a coal-fired power plant to reduce emissions of mercury (Hg) as well as NO_{X} using partially-combusted coal particles (also called adsorbent).

To comply with clean air environmental regulations, such as the maximum achievable control technologies (MACT), regarding air pollutants which include mercury emissions, utilities have sought alternative mercury control technologies. One such alternative technology is to use conventional, commercially available activated carbon (AC) sorbents, which have been shown to remove mercury at carbon-to-mercury weight ratios up to 100,000:1. The activated carbon (AC) sorbent is generally obtained by heating carbonaceous material in the absence of air, and then introducing carbon dioxide to control the carbon oxidation process. The resulting activated carbon sorbent has a large surface area and microporous internal structure that facilitate adsorption or absorption of various contaminants from flue gas streams, including mercury. A disadvantage of use of commercially available activated carbon sorbents produced offsite is that the cost of purchasing and transporting commercially produced activated carbon sorbent is relatively high, currently in the range of $1,100 per ton. Also, a need for onsite storage of activated carbon for an extended period of time, typically in silos, can increase capital costs.

In U.S. Pat. No. 6,521,021 (hereinafter, the '021 patent) there is disclosed a system and method of mercury emission reduction accomplished by removing partially combusted coal from a boiler's combustion chamber of a coal fired power plant. This coal and gas mixture is then mechanically separated to extract a thermally-activated sorbent and a “clean” flue gas recirculation (FGR) stream. After sufficient mass of thermally-activated sorbent material from the stream has been collected into a hopper (in practical applications, the sorbent in transferred to a silo beneath the hopper), the thermally-activated sorbent is reintroduced by air-driven pneumatic means into the plant's flue gas stream where it contacts and adsorbs mercury in the flue gas stream to reduce emissions thereof. The mercury-sorbent combination is then removed from the flue gas stream utilizing a particulate collection device. Mercury removal efficiencies of commercially available activated carbon (AC) and thermally-activated sorbents are comparable.

Industry implementation of the system and method described in the '021 patent has revealed several drawbacks. For instance, the thermally-activated carbon sorbent collected in the hopper (element 52 in the '021 patent) is very hot, typically in the temperature range of about 1093° C. (2000° F.). Actual field experience with the system described in the '021 patent has shown carbon self-ignition and fire spread in both the collection hopper (52) and a silo beneath the hopper (52). Such fires represent serious industrial safety hazard to plant personnel and damages to plant equipment. Furthermore, the use of a cyclone separator (element 44 in '021) and gas pump (element 42 in the '021 patent) lead the disclosed system to operate on a batch basis rather in a continuous fashion, and to producing a considerable pressure drops.

In the '021 patent, the use of the hopper (52) creates a need to pneumatically re-inject the collected sorbent into the flue gas downstream of a combustion chamber (element 20 in the '021 patent). The need to add kinetic energy to the batch-collected sorbent particles increases system capital costs for the pneumatic equipment and associated control methods, as this technology constantly needs to be updated as mercury capture standards change to meet the current emission standards. Moreover, a pneumatic injection system introduces air and, hence, oxygen to the hot thermally-activated sorbent, which can increase a risk of self ignition and fire hazard.

Furthermore, the cyclone separator (44) disclosed in the '021 patent lacks the ability to efficiently remove very fine coal particles in the flue gas leaving the combustion chamber (20). These fine coal particles can have diameters of less than 1 μm. The inability of the cyclone separator (44) to collect fine particles into the sorbent stream negatively affects the efficiency of mercury capture from flue gas downstream of the combustion chamber (20). This is due to the larger surface-area-to-volume ratio of the fine sorbent particles. Thus, mercury capture efficiency would degrade by the inability to capture very fine sorbent particles in the cyclone separator (44) disclosed.

### SUMMARY

A method of separating a coal particle laden gas mixture into a flue gas recirculation stream and a concentrated sorbent stream includes initiating combustion of a mixture of air and coal in a combustion chamber, extracting a mixture of flue gas and partially-combusted coal particles from the combustion chamber, inducing flow of the mixture of flue gas and partially-combusted coal particles toward a core separator apparatus, and separating the mixture of flue gas and partially-combusted coal particles into the flue gas recirculation stream and the concentrated sorbent stream using a centrifugal action of the core separator apparatus. The recirculation stream and the concentrated sorbent stream flow out of the core separator apparatus on a substantially continuous basis.

### BRIEF DESCRIPTION OF THE DRAWINGS

FIG. 1 is a schematic diagram of a coal-fired plant emission control system according to the present invention.

FIG. 2 is a schematic diagram of an alternative embodiment of the coal-fired plant emission control system.

FIG. 3 is a perspective view of an embodiment of a core separator for use with the coal-fired plant emission control system.

FIG. 4 is a schematic cross-sectional view of another embodiment of a core separator having electrostatic functionality for use with the coal-fired plant emission control system.

### DETAILED DESCRIPTION

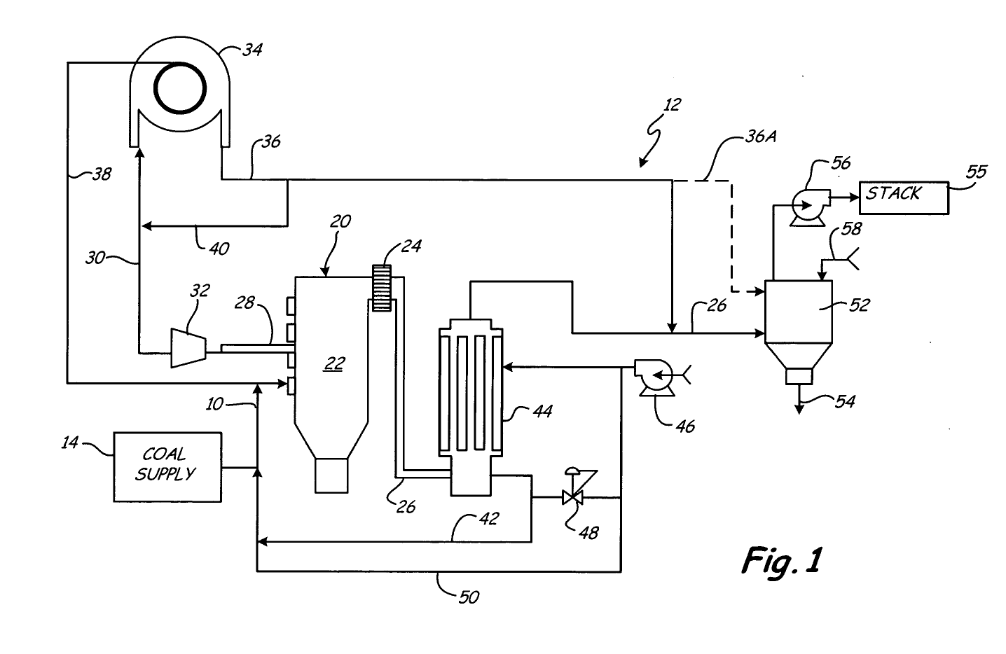

FIG. 1 is a schematic diagram of a coal-fired power plant 12 that includes a coal supply 14 and a boiler 20. The coal from the coal supply 14 can be in a pulverized form. An air-coal mixture 10 is forced into a combustion chamber 22 of the boiler 20. The mixture 10 is burned in the boiler's combustion chamber 22 at temperatures ranging from approximately 537 to 1649° C. (1000 to 3000° F.). The combustion process generates gaseous products and particulate matter (PM), and mercury (Hg) can be released. These coal combustion products that are produced in the combustion chamber 22 then pass into a convection section 24 of the boiler 20 and eventually exit the boiler 20 into the duct work 26 of the plant 12. In the art, gas leaving the combustion chamber 22 is termed flue gas.

A suitable extraction probe or lance 28 is used to continuously extract from the combustion chamber 22 a desired stream of a mixture 30 made up of flue gas laden with partially-combusted coal particles (i.e., thermally-activated sorbent, synonymously called a thermally-activated adsobent). In one embodiment, the probe 28 is hollow ceramic pipe with external cooling and uses suction power to extract the mixture 30 from the combustion chamber 22. The extracted mixture 30 from the combustion chamber 22 contains partially-combusted coal particles. The partially-combusted coal particles generally have a large surface area to volume ratio and are effective in adsorbing mercury. Motive force (i.e., suction at the probe 28) for this continuous extraction process is provided by a suction fan 32 having a variable-speed motor that enables extraction at a desired flow rate by controlling the rpm of the variable-speed motor. Capacity of the suction fan 32 can be increased or decreased to achieve desired extraction flow rate. Other functions of the suction fan 32 are described below.

The mixture 30 then flows from the probe 28 and suction fan 32 to a core separator 34. The mixture 30, which is a particle-laden gas flow, undergoes a centrifugal separation process in the core separator 34 to removes particulates from carrier gas. Most of, or at least a portion of, the thermally-activated sorbent is separated or bled from the mixture 30 and diverted into a concentrated sorbent stream 36. In one embodiment, approximately 10% by volume of the mixture 30 is diverted to the concentrated sorbent stream 36. The remainder of the mixture 30, including carrier gas from the mixture 30 as well as a relatively small portion of unburned hydrocarbons, is carried as a flue gas recirculation (FGR) stream 38 that is mixed with the incoming combustion air of the mixture 10 and returned back to the combustion chamber 22. A portion of the concentrated sorbent stream 36 designated as a recycle stream 40 can be continuously diverted and blended with the mixture 30 entering the core separator 34 in order to achieve a desired particle diameter in the recirculation stream 38. The configuration and operation of embodiments of the core separator 34 are explained in greater detail below.

The flue gas exiting the boiler 20 is typically used to preheat air 42 prior to being mixed with pulverized coal from the coal supply 14 and injected into the combustion chamber 22 as the coal-air mixture 10. This preheating generally occurs in a heat exchanger (economizer) 44 that is connected to the combustion chamber 22 downstream via duct work 26. A combustion air blower 46 provides motive force for the pre-heated air 42 passing through the heat exchanger 44. The heat exchanger 44 cools the flue gas, and transfers some of that thermal energy to the air 42. A bypass valve 48 permits air 50 to pass to the combustion chamber 22 without preheating.

The concentrated sorbent stream 36, or a portion thereof, can be reintroduced into the flue gas in the duct work 26 upstream or downstream of the heat exchanger 44. In the illustrated embodiment, the concentrated sorbent stream 36 is introduced to flue gas in the duct work 26 downstream of the heat exchanger 44. The portion of the concentrated sorbent stream 36 introduced to the duct work 26 is exposed to the flue gas stream where sorbent particles adsorb mercury and potentially other contaminants. It should be noted that because the concentrated sorbent flow 36 depends on the speed of the suction fan 32, the flow rate of the concentrated sorbent stream 36 can be increased or decreased as desired by adjusting the fan 32, which means that the capital costs associated with re-injection and control of adsorbent flow can be reduced.

A particulate collection system 52 is provided at a downstream location in the plant 12. The particle collection system 52 can comprise a fabric filter (i.e., a bag house), electrostatic precipitator (ESP), cyclone particle collector, or other known particle collection apparatus. The collection system 52 allows captured material 54 (e.g., fly ash and spent sorbent) to be collected for disposal using an environmentally acceptable approach. Capturing this material 54 reduces mercury emissions leaving the power plant 12. Remaining flue gas can be exhausted through a stack 55, and can be propelled through the stack by an induced draft fan 56. In the illustrated embodiment where the particle collection system 52 used to collect the mercury-loaded (spent) sorbent particles is a fabric filter/bag house, a pulsed air system 58 can be used to clear the fabric filter/bag house and to collect the captured material 54. Alternatively, mechanical rappers can be used to clean the fabric filter/bag house.

The concentrated sorbent stream 36 is injected into flue gas in the duct work 26 upstream of the collection system 52 (which can remove fly ash and spent sorbent mixture loaded with, e.g., adsorbed mercury). Alternatively and depending on how much mercury is to be removed from the flue gas, some or all of the concentrated sorbent stream 36 can be diverted directly to the collection system 52 without being introduced into the duct work 26 and without mixing with flue gas. The suction fan 32, as well as suitable valving (not shown) can be used to increase or decrease the flow rate of the extracted stream (30) and, hence, the concentrated sorbent stream 36 bypassing duct work 26 to directly enter the particulate collection system 52 (see dashed line 36A). The temperature of the concentrated sorbent stream 36 just prior to reinjection into the duct work 26 or direct injection to the particulate collection system 52 is sufficiently below the coal self-ignition temperature. Also, lower temperatures, e.g., less than about 204° C. (400° F.), enhance mercury adsorption on the partially-combusted coal particles (sorbent).

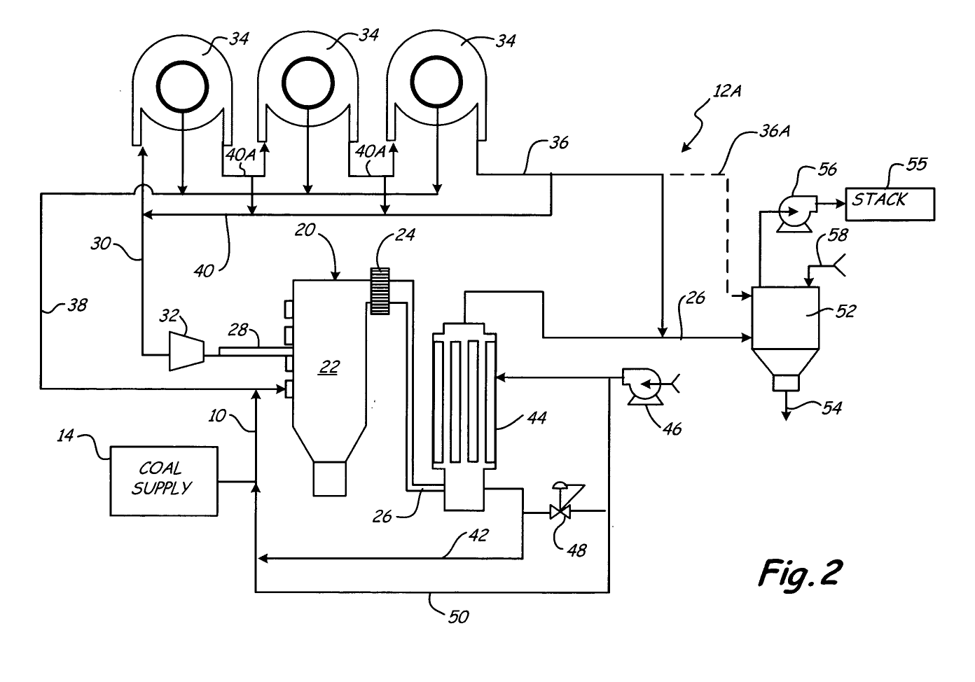

FIG. 2 is a schematic diagram of an alternative embodiment of a coal-fired plant 12A. The configuration and operation of the plant 12A is generally similar to that described above with respect to the plant 12 shown in FIG. 1. However, the plant 12A includes a plurality of core separators 34 connected in series. In the illustrated embodiment, three core separators 34 are provided to demonstrate the concept of using more than one core separator connected in series. The capacity of the plant 12A to continuously create the concentrated sorbent stream 36 and to re-circulate the “clean” recirculation stream 38 of gas to the combustion chamber 22 can be increased or decreased as desired by the addition or subtraction of core separators 34 connected in series. The embodiment shown in FIG. 2 provides flexibility and robustness in handling mercury emission control requirements based on environmental regulations (e.g., the MACT Rule for mercury control) as well as the type of coal being combusted in the boiler. With a series of core separators 34, a recycle stream 40A can be implemented between adjacent core separators 34 to produce a desired particle diameter in the “clean” recirculation stream 38, in addition to the recycle stream 40 that is mixed with the mixture 30.

In operation, the core separator 34 helps remove particulates from the mixture 30 using a mechanical centrifugal action. The centrifugal action as the mixtures 30 flows and turns within the core separator 34 helps to mechanically separate the concentrated sorbent stream 36 from the incoming mixture 30, as the thermally-activated sorbent particles are urged radially outward and separate from the carrier flue gas. The remaining flue gas of the mixture 30, now carrying fewer particulates, exits the core separator 34 through the gas stream outlet 64 as the “clean” recirculation stream 38. Flow through the core separator 34, including the concentrated sorbent stream 36 and the “clean” recirculation stream 38, can be substantially continuous.

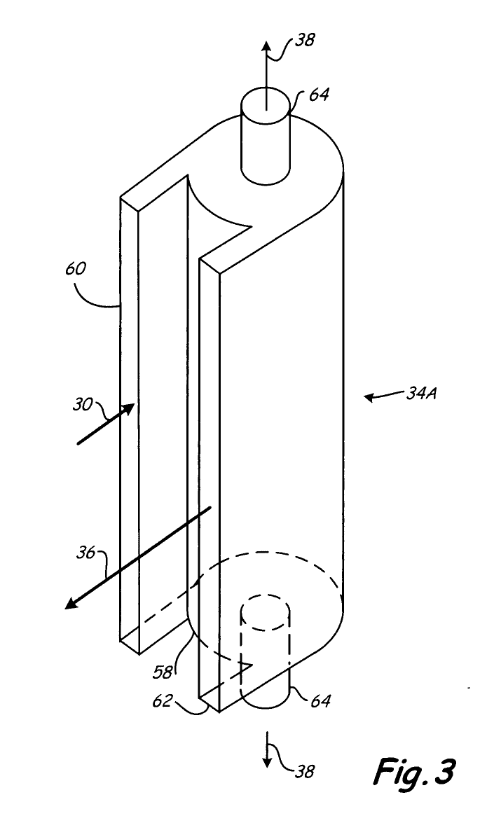

FIG. 3 is a perspective view of an embodiment of a core separator 34A that has an elongate, generally cylindrically-shaped body 58 and further includes a gas stream inlet 60, a particulate outlet 62, and gas stream outlets 64. The gas stream inlet 60 and the particulate outlet 62 extend from the separator 34A in generally the same direction, though they need not be parallel. The gas stream inlet 60 accepts the mixture 30, comprising flue gas and thermally activated sorbent particles. The gas stream inlet 60 and the particulate outlet 62 extend generally tangentially with respect to the body 58. In the illustrated embodiment, the gas stream inlet 60 and the particulate outlet 62 are each configured as slots with substantially rectangular cross-sections and each extend substantially an entire length of the body 58. The gas stream outlets 64 each extend substantially perpendicular to both the gas stream inlet 60 and the particulate outlet 62 (i.e., in axial or longitudinal directions). The mixture 30 (or alternatively recycle stream 40A) entering the gas stream inlet 60 is turned within the body 58 of the separator 34A, and, through a mechanical, centrifugal action, the concentrated sorbent stream 36 (or alternatively the recycle stream 40A) is expelled from the separator 34A through the particulate outlet 62. The “clean” recirculation stream 38 can exit the separator 34A from either of the gas stream outlets 64. A similar centrifugal separation process is described in U.S. patent application Ser. No. 11/517,710, filed Sep. 8, 2006, entitled METHOD AND SYSTEM FOR CONTROLLING CONSTITUENTS IN AN EXHAUST STREAM and U.S. Pat. No. 5,180,486 entitled POTENTIAL FLOW CENTRIFUGAL SEPARATOR SYSTEM FOR REMOVING SOLID PARTICULATES FROM A FLUID STREAM, both of which are hereby incorporated by reference.

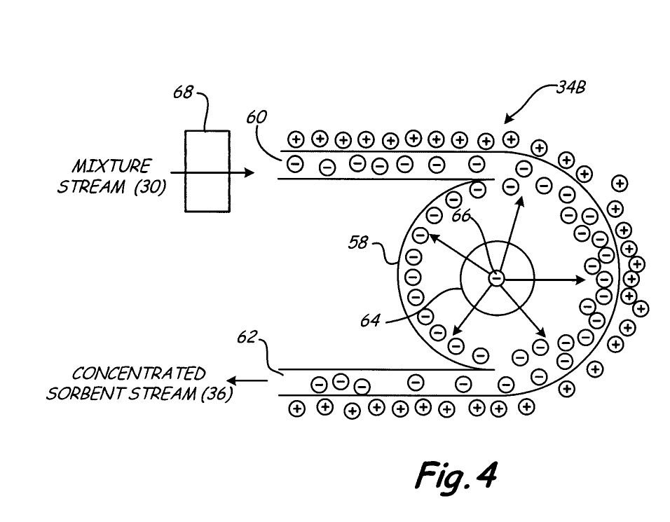

FIG. 4 is a schematic cross-sectional view of another embodiment of a core separator 34B that includes optional electrostatic separation functionality. The illustrated core separator 34B is generally similar to the separator 34A described above, but further includes an electrode 66 and a pre-charger 68. The mixture 30 (or recycle stream 40A) can be charged using the pre-charger 68 before reaching the gas stream inlet 60, in order to give incoming particles an electrical charge. In one embodiment, the core separator 34 can be configured as disclosed in commonly-assigned U.S. patent application Ser. No. 11/520.261, entitled “Electrostatic Particulate Separation System and Device”, filed Sep. 13, 2006, which is hereby incorporated by reference in its entirety.

Mechanical separation due to centrifugal action is further enhanced by the electrode 66, which can be charged with a high voltage current. The high voltage electrode 66 extends through the gas stream outlet 64 of the separator 34B and establishes an electric potential relative to an interior wall of the body 58 of the separator 34B. In the illustrated embodiment, the electrode 66 forms a positive electrostatic field within separator 34 to attract the thermally activated sorbent particles in the mixture 30 (or recycle stream 40A), negatively-charged by the pre-charger 68, toward the interior wall of the body 58. The polarity of the potential applied to the high voltage electrode 66 is the same as the charge imparted on the thermally activated sorbent particles. Thus, the electrostatic field repels the thermally activated sorbent particles in the mixture 30 from a central core of the separator 34 in a radially outward direction, allowing the thermally activated sorbent particles to follow the interior wall of the body 58 until being expelled out the particulate outlet 62.

However, it should be recognized that other configurations of the core separator 34 can be utilized in conjunction with the present invention, the core separators 34A and 34B are disclosed merely by way of example.

Accordingly, the present invention provides a method and apparatus to continuously and efficiently reduce coal-fired plant mercury emissions. In addition to removing mercury by adsorption on injected partially-combusted coal particles (sorbent) created on-site, mixing combustion air with a flue gas recirculation (FGR) stream reduces combustion temperature as a result of diluting the oxygen concentration in the combustion air entering the boiler's combustion chamber. The result of reducing the combustion flame temperature is to reduce the emission of thermal NO_{X}. According to the present invention, thermally activated sorbent comprising partially combusted coal particles in a carrier gas flow can be extracted from a combustion chamber of a boiler and then centrifugally separated into a “clean” recirculation stream and a concentrated sorbent stream using a core separator. The core separator allows continuous flow of the concentrated sorbent stream, thereby eliminating the requirement of a cyclone separator, hopper and a silo beneath the hopper, which in turn reducing a risk of self-ignition of high temperature sorbent particles collected in the cyclone separator, hopper and silo. Moreover, the present invention allows continuous flow to be maintained without the need for pneumatic injection of thermally-activated sorbent from a hopper or silo beneath the hopper. Furthermore, by producing thermally-activating sorbent on-site and also using that thermally activated sorbent for mercury emissions reduction, substantial cost savings (on the order of 80% or more) can be recognized over systems that use conventional activated carbon produced off-site.

Although the present invention has been described with reference to preferred embodiments, workers skilled in the art will recognize that changes may be made in form and detail without departing from the spirit and scope of the invention. For instance, the power plant configuration of the disclosed embodiment is merely exemplary, and the present invention can be applied to nearly any type of plant configuration.

What is claimed is:

1. A method of separating a coal particle-laden gas mixture into a flue gas recirculation stream and a concentrated sorbent stream, the method comprising:
a) initiating combustion of a mixture of air and coal in a combustion chamber;
b) extracting a mixture of flue gas and partially-combusted coal particles from the combustion chamber;
c) inducing flow of the mixture of flue gas and partially-combusted coal particles toward a core separator apparatus; and
d) separating the mixture of flue gas and partially-combusted coal particles into the flue gas recirculation stream and the concentrated sorbent stream using a centrifugal action of the core separator apparatus, wherein the recirculation stream and the concentrated sorbent stream flow out of the core separator apparatus on a substantially continuous basis.

2. The method of claim 1, wherein the step of separating the mixture of flue gas and partially combusted coal particles into the recirculation stream and the concentrated sorbent stream includes the use of a plurality of core separators connected in series.

3. The method of claim 1 and further comprising:
diverting a recycle stream from the concentrated sorbent stream into the coal particle laden gas mixture entering the core separator apparatus, wherein the recycle stream contains sorbent particles.

4. The method of claim 1, wherein the step of removing the mixture of flue gas and partially combusted coal particles from the combustion chamber comprises inserting a probe at least partially into the combustion chamber.

5. The method of claim 1, wherein the step of separating the mixture of flue gas and partially combusted coal particles into the recirculation stream and the concentrated sorbent stream further includes:
utilizing electrostatic force to help separate partially combusted coal particles from the flue gas within the core separator apparatus.

6. A method of emission control comprising:
initiating combustion of a mixture of air and coal in a combustion chamber;
removing a mixture of flue gas and partially combusted coal particles from the combustion chamber;
inducing flow of the mixture of partially-combusted coal particles and flue gas toward a core separator apparatus; and
separating the mixture of flue gas and partially-combusted coal particles into a flue gas recirculation stream and a concentrated sorbent stream, the separating step comprising:
carrying the partially-combusted coal particles in the flue gas along a first path;
turning a flow of the partially-combusted coal particles in the flue gas carrier such that a centrifugal action urges the partially-combusted coal particles radially outward; and
dividing the flow into a radially outward portion that comprises the concentrated sorbent stream and a radially inward portion that comprises the flue gas recirculation stream.

7. The method of claim 6 and further comprising:
utilizing electrostatic force to help urge radially outward movement of the partially combusted coal particles.

8. The method of claim 6 and further comprising:
introducing at least a portion of the concentrated sorbent stream to a flue gas stream at a location downstream from the combustion chamber for reducing mercury emissions present in the flue gas stream.

9. The method of claim 6 and further comprising:
capturing at least a portion of the concentrated sorbent stream utilizing at least one of an electrostatic precipitator and a fabric filter.

10. The method of claim 6 and further comprising:
exhausting flue gas from the combustion chamber to a stack for discharge;
introducing partially-combusted particles from the concentrated sorbent stream into the flue gas stream between the combustion chamber and the stack for removing mercury from the flue gas stream; and
capturing at least a portion of the sorbent particles introduced to the flue gas stream prior to the discharge of flue gas stream from the stack.

11. The method of claim 6, wherein the step of separating the mixture of flue gas and partially-combusted coal particles into the flue gas recirculation stream and the concentrated sorbent stream includes performing the step of separating the mixture of flue gas and partially-combusted coal particles into the flue gas recirculation stream and the concentrated sorbent stream a plurality of times utilizing a plurality of core separators connected in series.

12. The method of claim 6 and further comprising:
diverting a recycle stream from the concentrated sorbent stream into the coal particle laden gas mixture entering the core separator apparatus, wherein the recycle stream contains sorbent particles.

13. The method of claim 6, wherein the step of removing the mixture of flue gas and partially-combusted coal particles from the combustion chamber comprises inserting a probe into the combustion chamber.

14. A system for mercury and NO_{X} emissions reduction, the system comprising:
a combustion chamber for a boiler;
a coal-air fuel supply operably connected to the combustion chamber;
a probe configured to remove a mixture of flue gas and partially-combusted coal particles from the combustion chamber;
a core separator apparatus comprising:
a substantially cylindrical body;
an inlet slot for accepting the mixture of flue gas and partially combusted fuel particles in the body, the inlet slot arranged in a tangential orientation with respect to the body;
a clean gas outlet arranged in a substantially axial direction with respect to the body;
a particle outlet slot arranged in a tangential orientation with respect to the body, wherein a centrifugal action turns the mixture of flue gas and partially-combusted coal particles within the body of the core separator apparatus between the inlet slot and the outlet slot to, and separates the mixture of flue gas and partially-combusted coal particles into a concentrated particle stream that flows out the particle outlet slot and a flue gas recirculation stream that flow out the gas outlet;
an injector assembly for introducing at least a portion of the concentrated particle stream into the flue gas stream downstream from the combustion chamber for removing mercury from the flue gas stream.

15. The system of claim 14 and further comprising:
a particle capture subsystem for capturing at least a portion of the concentrated particles stream introduced to the flue gas stream prior to discharging the flue gas stream through a stack.

16. The system of claim 15, wherein the particle capture subsystem comprises a fabric filter.

17. The system of claim 15, wherein the particle capture subsystem comprises an electrostatic precipitator.

18. The system of claim 14 and further comprising:
a pre-charger for electrically charging partially-combusted coal particles from the combustion chamber upstream from the inlet slot of the core separator; and
an electrode extending into the body of the core separator for generating an electrostatic force to help separate the charged partially combusted coal particles from the flue gas within the core separator apparatus.

19. The system of claim 14 and further comprising:
a suction fan for inducing flow of the mixture of flue gas and partially-combusted coal particles extracted from the combustion chamber by the probe toward the core separator apparatus.

20. The system of claim 14, wherein the fuel mixture comprises air and pulverized coal.
